(19) United States
(12) Patent Application Publication
(10) Pub. No.: US 2011/0035159 A1
(43) Pub. Date: Feb. 10, 2011

(54) CORRECTING BIOLOGICAL SIGNAL MEASUREMENTS FROM PARALLEL MEASUREMENT DEVICES

(75) Inventors: Sami Kilpinen, Helsinki (FI); Reija Autio, Viiala (FI); Matti Saarela, Tampere (FI)

Correspondence Address: YOUNG & THOMPSON, 209 Madison Street, Suite 500, Alexandria, VA, 22314, US

(73) Assignee: MEDISAPIENS OY, Helsinki (FI)

(21) Appl. No.: 12/936,931

(22) PCT Filed: Apr. 8, 2009
(86) PCT No.: PCT/FI09/50264

§ 371 Date: Oct. 8, 2010

(30) Foreign Application Priority Data
Apr. 10, 2008 (FI) 20085302

(51) Int. Cl. G06F 19/00

(52) U.S. Cl. 702/19; 702/85

(57) ABSTRACT

A computer-implemented method and apparatus for correcting data sets from microarray measurements of gene expression values made with several different microarray versions. The method comprises obtaining data sets (210) of expression values of several genes of biological samples (202), made with several different microarray versions; normalizing (212) the data sets; determining a first gene-specific distribution parameter (220) for each microarray version and a second gene-specific distribution parameter (222) for a combination of microarray versions; determining a gene-specific correction element (226) for each microarray version based on the discrepancy (224) between the first and second gene-specific distribution parameters; correcting a gene's expression value with the gene-specific correction element (226) for the microarray version on which the gene's expression value is based; and storing (118) the gene's corrected expression value (228) in a physical memory (230). The technique can be generalized to properties other than gene expression values.

### FIELD OF THE INVENTION

The invention relates generally to instrumentation and specifically to a technique of processing measurements of biological signals from massively parallel measurement devices. An illustrative but non-restrictive example of a massively parallel measurement device is a microarray which is configured to produce measurements from one or more biological samples or entities via several measurement spots which occupy the measurement device simultaneously. An illustrative but non-restrictive list of such biological entities includes genes, splice variants of genes, micro-RNAs and other types of ribo- or deoxyribonucleic acid sequence combinations, proteins, sugars, lipids, metabolites. In order to keep the description compact and understandable, embodiments will be described which relate to correction of microarray measurements relating to gene expression, but the embodiments and techniques described herein are applicable to correction of measurements of other types of biological signals produced by other types of massively parallel measurement devices.

### BACKGROUND OF THE INVENTION

Microarray measurements for analyzing gene expression data are becoming crucial part of modern biomedical research. A problem underlying the invention relates to the fact that measurements obtained from one microarray are not comparable to those obtained from microarrays of a different version, even in cases wherein all the microarrays are produced by the same manufactures such as Affymetrix, whose microarray platform is probably the most popular microarray platform at the moment. The expression ‘microarray version’ is used herein for microarrays of different design. The microarray versions may originate from the same manufacturer or from different manufacturers. For the purposes of the present invention, all microarrays within the same version can be considered equivalent. Strictly speaking, microarrays within the same version may not be exactly equivalent, but there is no way to separate true biological signals from variations among individual microarrays. Another interpretation for the term “version” is such that all measurement devices may be virtually equivalent but they are used with different measurement software, methods or protocols.

A traditional technique for calibrating a measurement instrument is to measure the same quantity with the instrument to be calibrated and a reference instrument, and use the discrepancy between instruments to determine an instrument-specific correction, such as an offset, factor or calibration curve. But there are several reasons why such a traditional approach is impracticable for microarray measurements relating to gene expression data. Firstly, microarray measurements are not easily reproducible because they relate to specific biological samples which are not easily reproducible. Secondly, the inventors of the present invention have discovered that any instrument-specific correction is severely limited by the fact that different microarray versions measure different genes differently. Gene x may have a higher indicated expression value from microarray version 1 than from microarray version 2, while gene y may have a higher reading from version 2 than from version 1. This is not to say that any instrument-specific correction is useless but it is only effective up to a certain point beyond which it cannot be improved.

### BRIEF DESCRIPTION OF THE INVENTION

An object of the invention is to alleviate the above-described problem which is the mutual incompatibility between results from different microarray versions or other types of massively parallel measurement devices. The problems is alleviated by a method, computer system and software product which are defined by the attached independent claims. The dependent claims and the present patent specification describe specific embodiments of the invention.

The inventive correction technique is applicable to measurements from a wide variety of measurement devices for which there is no commonly-used generic name. As used in the context of the present invention, the term “massively parallel measurement device” refers to a measurement device which has the following properties. “Measurement device” is a device or instrument which measures one or more quantitative or semi-quantitative properties of biological entities or samples. An illustrative but non-restrictive list of such biological entities includes genes, splice variants of genes, micro-RNAs and other types of ribo- or deoxyribonucleic acid sequence combinations, proteins, sugars, lipids and metabolites. “Quantitative property” is a property which can be expressed in terms of absolute or relative quantity. For example, a sample's mass and volume are examples of absolute quantities while concentration is an example of a relative quantity. “Semi-quantitative property” means a numerical approximation of a true quantitative result. “Parallel” means that the one or more biological entities or samples occupy several measurement spots in the measurement device simultaneously, although the multiple measurement spots may be read from the measurement device sequentially. “Massively parallel” relates to one or both of two characteristic features. Firstly, the massively parallel measurement devices are usually manufactured by means of large-scale integration (LSI) technology, which makes it possible to produce large numbers of relatively inexpensive instruments. The large number of the manufactured devices and their relatively low cost make individual calibration of measurement devices prohibitively expensive. In many cases the measurement devices are discarded after each measurement, which obviously makes individual calibration of measurement devices impossible. Secondly, the large amount of publicly available measurement data produced by means of such measurement devices makes it possible to at least partially correct systematic errors of the measurement devices via statistical correction techniques as specified in more detail in the following description.

For the interest of clarity and brevity, the following description of the invention is based on the assumption that microarrays, genes and expression levels are representative examples of the measurement technology, biological entity and property value, respectively. In other words, each occurrence of microarray can be generalized other massively parallel measurement devices, each occurrence of gene can be generalized to many other biological entities and each occurrence of a gene's expression level can be generalized to many other property values.

The invention is partially based on the discovery that there is a certain point beyond which the incompatibility problem cannot be eliminated with any instrument-specific corrections. The invention is also based on the realization that in addition to being microarray version-specific, the correction must also be gene-specific. Fulfilling this requirement is a tremendous undertaking because each microarray data set normally includes data for thousands or tens of thousands of genes. This means that instead of a single correction element for an entire microarray version, thousands or tens of thousands of correction elements must be determined for each microarray version. Thus there clearly seems to be a scalability problem: It is clearly impossible to determine such a tremendous number of gene-specific correction elements by comparing individual gene expression values between a microarray to be calibrated and a reference instrument.

It turns out, however, that while this scalability problem cannot be effectively and economically solved for a moderate number of data sets, such as a few dozen data sets, it can be solved if the number of data sets is sufficiently large, such as several hundred or, preferably, over a thousand data sets for each microarray version. This is because with a sufficiently large number of data sets we can assume with reasonable certainty that the data for any combination of gene and microarray version should comprise all possible expression values. This means that it is not necessary to measure same biological samples with microarray version a and microarray version b. Instead we can make the assumption that the collection of samples measured with microarray versions a and b are supposed to produce identical or nearly-identical distributions of expression level values for each gene. Now, if an appropriate distribution parameter, such as average, mean, or the like, is determined for each gene and microarray version, and again for that gene and a combination of microarray versions, the discrepancy between the two distribution parameters can be used to determine the gene-specific correction with which the expression data of a gene, as indicated by a given microarray version, can be made compatible with expression data from the combination of microarray versions.

It was stated above that the data for any combination of gene and microarray version should comprise all possible expression values, but this may be an idealized state of events which cannot be achieved in every case. Experiments carried out by the inventors indicate, however, that the inventive correction technique improves on the prior art techniques even in cases wherein only a representative set of expression values are present.

Before correcting across versions, an intra-dataset normalization, ie, a normalization within each data set, is generally performed first, although such normalization is not absolutely necessary for the present invention. If no intra-dataset normalization is performed, the data sets of the biological samples are preferably pre-processed such that they at least have approximately the same scale of intensity values. The inventors have experimented with the following intra-dataset normalization algorithms:
pure MAS without any further normalization (abbreviated “MAS”),
expression value standardization (abbr. “Z”),
housekeeping gene centering (abbr. “HK”),
equalization transformation (abbr. “EQ”); and
Weibull distribution based normalization (abbr. “WBL”).

Reference documents for the above-mentioned intra-dataset normalization algorithms are listed at the end of this patent specification.

The inventors have discovered that in a study based on 1464 samples from 35 different healthy tissues and cells including 15931 genes, the ability of these intra-dataset normalization algorithms to correctly classify samples, from which the data sets were obtained, varied between 81.4 and 84 percent. However, all of these algorithms received a significant accuracy boost to between 90.5 and 90.8 percent when used in connection with an embodiment of the inventive correction technique.

The technique according to the invention can be used together with many different intra-dataset normalization techniques, five of which (with abbreviations MAS, Z, HK, EQ and WBL) are presented above. The fact that all of the intra-dataset normalization techniques received a significant accuracy boost (from 81.4-84 to 90.5-90.8 percent) when used in combination with the inventive technique suggests that the inventive technique is not sensitive to details of the intra-dataset normalization technique being used and can be used with a wide variety of normalization techniques.

In an illustrative but non-restrictive implementation of the inventive technique, the assumption is made that the mean of expression values of one gene in each microarray version should be the same. If the mean value of some of the microarray versions differs substantially from the mean value of other microarray versions, such differences are assumed to be caused by different microarray versions. The present invention aims to correct this variation. The inventive technique requires the collection of samples to be large, so that one can assume the distribution of logarithmic values of each gene k to be the total distribution of all potential expression values from all tissues for gene k in that microarray version i. An implementation of the inventive normalization technique normalizes the data to have the mean values μ_{i,k}=μk for all microarray versions i, where μₖ is the mean of all logarithmic values of the gene k. One illustrative but non-restrictive implementation of the invention is based on an assumption that the minimum and the maximum estimates for the gene value are reached and the range of the gene k should approximately be [aₖ, bₖ], where aₖ is the lowest 2% value and bₖ is the largest 2% value of gene k. After the correction with the gene- and microarray-specific correction element, none of the values should overstep this range for gene values. However, if the corrected value exceeds the range, the difference is diminished towards the range limits with coefficient c, 0<c1. Here, the coefficient is set to c=⅕. The corrected values can now be obtained with

\hat{x}_{k,j}=log ₂(x_{k,j})−(μ_{k,i}−μₖ)′, [1]

where:
x_{k,j}=value of gene k in sample j made with microarray version i;
μ_{k,i}=mean of the logarithmic values of gene k across microarray version i; and
μₖ=mean of the logarithmic values of gene k across all microarray versions.

Further, the resulting values are adjusted based on the equation

$${AGC\_Value}_{k , j} = \{ \begin{matrix}{b}_{k} + c ( {\hat{x}}_{k , j} - {b}_{k} ) , for {\hat{ x}}_{k , j} > {b}_{k} , \\ {a}_{k} - c ( {a}_{k} - {\hat{x}}_{k , j} ) , for {\hat{x}}_{k , j} < {a}_{k} , \\ {\hat{x}}_{k , j} , otherwise .\end{matrix} \qquad [ 2 ]$$

The mean values of distributions of microarray versions may be centered to have the same mean.

In the above description of the inventive technique, the mathematical concepts of “mean” and “logarithm” should be interpreted as illustrative but non-restrictive examples. The mean value of the gene's (logarithmic) distribution is only an illustrative example of the distribution parameter which is used to determine discrepancies between distributions, and the discrepancies between the distributions of different microarray versions can be determined on the basis of differences between other distribution parameters, such as average, n^{th} percentile, etc. Likewise, the logarithm of a gene's expression value is used as an illustrative but non-restrictive example of a mathematical function or operation that compresses value ranges. It is convenient to work with logarithmic values of quantities which vary over a large range but, as stated above, the inventive technique is not sensitive to details of the normalization algorithm being used, and many other range-compression functions or operations can be used instead of mathematically precise logarithm.

### BRIEF DESCRIPTION OF THE DRAWINGS

In the following the invention will be described in greater detail by means of specific embodiments with reference to the attached drawings, in which

FIG. 1 is a flow chart illustrating a method according to an embodiment of the invention;

FIG. 2 is a block diagram illustrating various data elements and information flows in an embodiment of the invention;

FIG. 3 illustrates the effect of the inventive technique for a prostate-specific gene KLK3 with five different microarray versions; and

FIG. 4 shows correlation results between technical replicates using various normalization methods with and without the inventive correction with the gene-specific correction element;

FIG. 5 also illustrates the effect of the inventive correction technique; and

FIG. 6 shows how the invention can be applied to correct readings from an external microarray whose output values did not contribute to the determination of the gene- and microarray-specific correction elements.

### DETAILED DESCRIPTION OF SPECIFIC EMBODIMENTS

As stated in the introductory portion of this patent specification, the specific embodiments described herein relate to correction of microarray measurements relating to gene expression, but those skilled in the art will realize that the embodiments and techniques described herein are applicable to correction of measurements of other types of biological signals produced by other types of massively parallel measurement devices provided that such parallel measurement devices produces large amounts of measurement data of one or more quantitative or semi-quantitative properties of the biological entities.

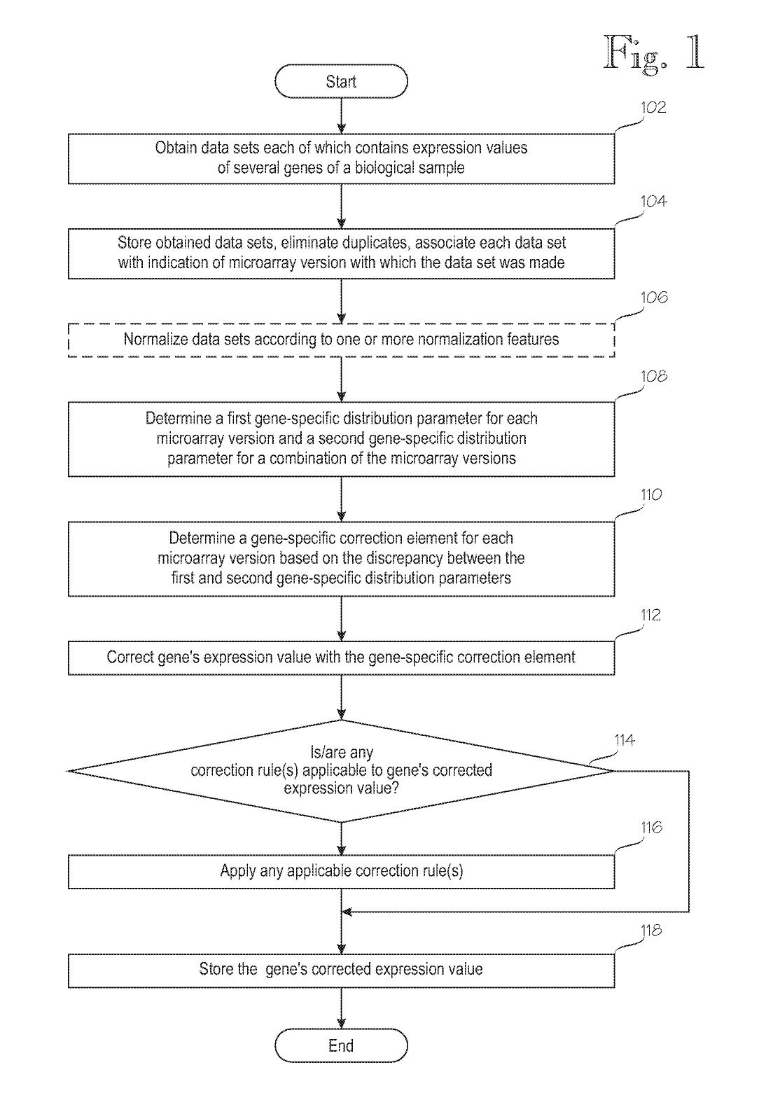

FIG. 1 is a flow chart illustrating a method according to an embodiment of the invention. Step 102 comprises obtaining data sets wherein each data set contains expression values of several genes of a biological sample, wherein the expression values of the data set are based on measurements made with one of the several different microarray versions. Typically each data set relates to a biological sample and contains expression values of several genes of that sample.

There are several alternative techniques for obtaining such data sets. For instance, suitable data sets may be published on the Internet. In a more likely situation, however, data which is readily available is “raw data”, ie, probe set values from a vast number of microarrays. In a typical case several probe sets measure any single gene, and the values of the probe sets which measure the same gene must be converted to expression values of the gene. A gene's expression value is set to a representative value, such as median, average or weighted average, of the values of the probe sets which measure the gene.

In one embodiment of the invention, the mapping from probe sets to genes is updated when an updated genome chart is available and the inventive data base needs to be published in an updated form.

Some microarray producers produce multi-channel microarrays in which multiple, such as two, different fluorescent materials can be used. Data from such multi-channel microarrays can be made compatible with the preset invention by processing each channel as a normal single-channel microarray.

Step 104 comprises storing the expression value data sets. Each data set is associated with an indication of the microarray version which produced the probe set values the data set is based on. It often happens that identical data sets are published in several sources. In order to avoid over-emphasizing data sets published more than once, it is beneficial to check if there are duplicates among the data sets and attempt to eliminate the duplicates, if they are detected. This is particularly relevant when the data sets and/or the underlying probe set values are obtained from varying sources on the Internet. Because identical data sets may be published under different identifications, such elimination of duplicate data sets is preferably based on the contents of the data set and may be accomplished by computing a hash value or multi-byte checksum over the contents of the data set. If the hash (or checksum or some other similar value) computed over the contents of the data set matches the hash of another data set, the data sets can be considered duplicates and only one is to be stored.

In an optional normalization step 106 the obtained and stored data sets are normalized according to one or more normalization features. Normalization is a statistical term which may not have a universally accepted definition, but within the context of the present invention, normalization means processing a data set of more or less relative values by means of one or more features which are considered absolute, or at least more absolute (=less relative) than the elementary values of the data set in general. For instance, such absolute features can include distribution or the expression value of certain “housekeeping” (HK) genes. Also, the MAS5 algorithm by Affymetrix comprises an internal normalization algorithm. The optional normalization step is presented here because it is the prevailing method in the prior art to overcome the problems outlined in the background section of this patent specification.

It is also customary to compress the range of the data set values, for instance by using logarithmic values. Although such compression is not necessary for the purposes of the present invention, it may be helpful in visualizing data set values which span a large range.

Step 108 comprises determining at least one first gene-specific distribution parameter for each microarray version and at least one second gene-specific distribution parameter for any combination of one or more microarray versions. For instance, the distribution parameters may comprise average value, mean value, n:th percentile value or other statistical function which produces a representative value (or set of values) from each data set. The distribution parameters may also comprise combinations of the above-mentioned or other statistical functions. For instance, the distribution parameters may comprise a combination of average value and variance.

Step 110 comprises determining a gene-specific correction element for each microarray version, based on the discrepancy between the first and second gene-specific distribution parameters.

Step 112 comprises producing the gene's corrected expression value by correcting the gene's expression value with the gene-specific correction element for the microarray version on which the gene's expression value is based.

In one illustrative but non-restrictive example, the normalization feature is or includes normal distribution and the distribution parameter is average value. This involves normalizing each data set with the assumption that the distribution is normal. The first gene-specific distribution parameter is then the average value calculated for each gene and microarray version, while the second gene-specific distribution parameter is the average value calculated for each gene and a combination of microarray versions (such as all microarray versions). Then a gene-specific correction element is determined based on the discrepancy between the first and second gene-specific distribution parameters. For instance, the gene-specific correction element can the ratio of the second gene-specific distribution parameter to the first gene-specific distribution parameter, whereby each gene's expression value is corrected by multiplying by that ratio.

Steps 114 and 116 relate to an embodiment which implements automatic correction of the gene's corrected expression value with a computer-readable correction rule set. Step 114 comprises checking whether any correction rules are applicable to the gene-specific correction element and or the corrected expression value. Step 116 comprises applying any applicable correction rule(s) to each gene's expression value. One simple but effective correction rule comprises defining a range [aₖ, bₖ] wherein aₖ and bₖ are low-cut and high-cut limits of the range such that only a small percentage of the expression values of gene k are below aₖ or above bₖ. The small percentage is between 0 and 10 percent, preferably 0.5 to 5% and optimally about 2%. If the corrected expression value of gene k is below aₖ or above bₖ, the correction is applied in full to the lower or upper limit aₖ or bₖ, after which only a fraction of the correction is applied. For instance, the fraction is preferably less than 40% and optimally about 20%.

Step 118 comprises storing the gene's corrected expression value in some physical memory.

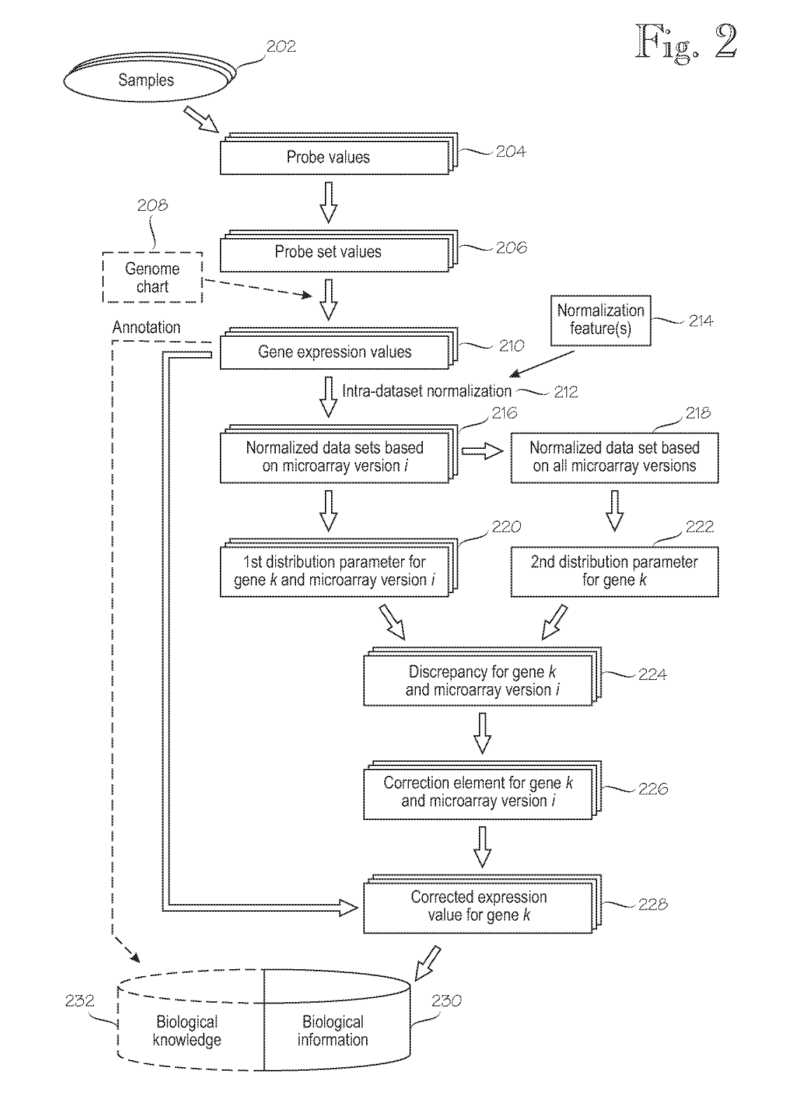

FIG. 2 is a block diagram illustrating various data elements and information flows in an embodiment of the invention.

A plurality of biological samples 202 are measured with microarrays which are of several different versions. A microarray result of a sample 202 contains measurement values for each of the probes, and these are denoted by reference numeral 204. The probes may be logically grouped into one or more probe sets such one or more probe set measures the expression level of each gene. Alternatively, one or more probes may measure each gene without such logical grouping. The probe values 204 or probe set values 206 are converted to gene expression values 210, typically with some mathematical operation resulting in one expression value (and possibly some quantification of deviation or similar statistical feature of the probe values 204 or the probe set values 206) for each gene 210. This operation can be performed in multiple steps such that probe values 204 are first combined to probe set values 206 and then combined into the above-mentioned gene expression values 210. Alternatively, direct conversion from probe values 204 to gene expression values 210 is also possible.

The mapping from probe values 204 or probe set values 206 to gene expression values 210 is influenced by knowledge of the human genome chart 208 (or the genome chart of other animals or plants under study). When the genome chart 208 is updated, the mapping from probe values or probe set values to gene expression values, as well as the successive information processing, can be updated as well.

The data structures and information flows above the gene expression values 210 are described for the sake of completeness but for the purposes of the present invention it suffices that someone has performed the measurements and published either the gene expression values 210 or the probe/probe set values 204, 206 which the gene expression values are based on. Therefore a typical implementation of the invention can begin with the assumption that the gene expression values 210 are available on bulk media or on the Internet, for example.

Reference numeral 212 denotes an optional intra-dataset normalization of the gene expression values 210. The intra-dataset normalization, if performed, may be based on one or more normalization features 214, such as a predetermined distribution or a set of housekeeping genes. Moreover, the intra-dataset normalization 212 may be implicit in the sense that the above-mentioned mathematical operation which combines probe or probe set values to gene expression values may perform normalization internally and any further intra-dataset normalization is not essential.

Reference numeral 216 denotes datasets each of which is based on measurements made with a microarray of version i. Another data set 218 is based on a combination of data sets analyzed by one or more microarray versions. The combination may comprise all microarray versions unless there is some reason to exclude some versions. Each of the data sets 216 and the data set 218 have a distribution of expression values (and potential statistics associated to each value) from which a distribution parameter, such as mean, average or n^{th} percentile can be determined.

A first gene-specific distribution parameter 220 is determined for each microarray version i, and a second gene-specific distribution parameter 222 is determined for the combination of the microarray versions. Between each of the first gene-specific distribution parameters 220 and the second gene-specific distribution parameter 222 there is a discrepancy 224, such as difference, ratio or some other statistical quantity which expresses the discrepancy between two distributions each of which has a representative distribution parameter.

If the intra-dataset normalization 212 is omitted, the data set 216 is the same as the data set 210, or in other words, the gene expression value data set 210 serves as input to blocks 218 and 220.

A gene-specific correction element 226 is determined for each gene k and microarray version i based on the discrepancy 224 between the first gene-specific distribution parameter 220 and the second gene-specific distribution parameter 222. The correction element 226 is determined is determined such that it minimizes or at least diminishes the discrepancy 224. The correction by the gene-specific correction element 226 produces a corrected expression value 228 for gene k which is stored in section 230 of a database system.

FIG. 2 shows an embodiment wherein the second data set 218 and the second gene-specific distribution parameter 222 are determined for a combination of several microarray versions, but this is not absolutely necessary. Instead it is possible to derive the second data set 218 and the second gene-specific distribution parameter 222 from data sets which are based on measurements made with one microarray version. If, for example, there are data sets based on measurements made with microarray versions a and b, it is not necessary to form a combination a+b, and the discrepancy 224 and correction element 226 for version a can be derived from the data set of version b alone. In a general case, the inventive technique comprises determining at least one first property-specific distribution parameter and at least one second property-specific distribution parameter for each property. The at least one first property-specific distribution parameter is determined for each version i of the parallel measurement device and the at least one second property-specific distribution parameter is determined for a combination of one or more of the versions of the parallel measurement device, wherein the combination of one or more the versions comprises at least one version other than version i.

In a typical application of the inventive data correction technique, the database system also contains a section 232 which contains biological knowledge, such as annotations of the gene expression values 210, which are made by biomedical experts. In this way the corrected gene expression values can be coupled with biological knowledge, including the annotations, but such biological knowledge relates to intellectual processes which are beyond the scope of the present invention.

In FIG. 2 solid boxes and arrows relate to physical information and information flows, while dashed ones relate to intellectual information and information flows which can benefit from the present invention but are not part of it. Stacked boxes represent data structures which exist separately for each microarray version i.

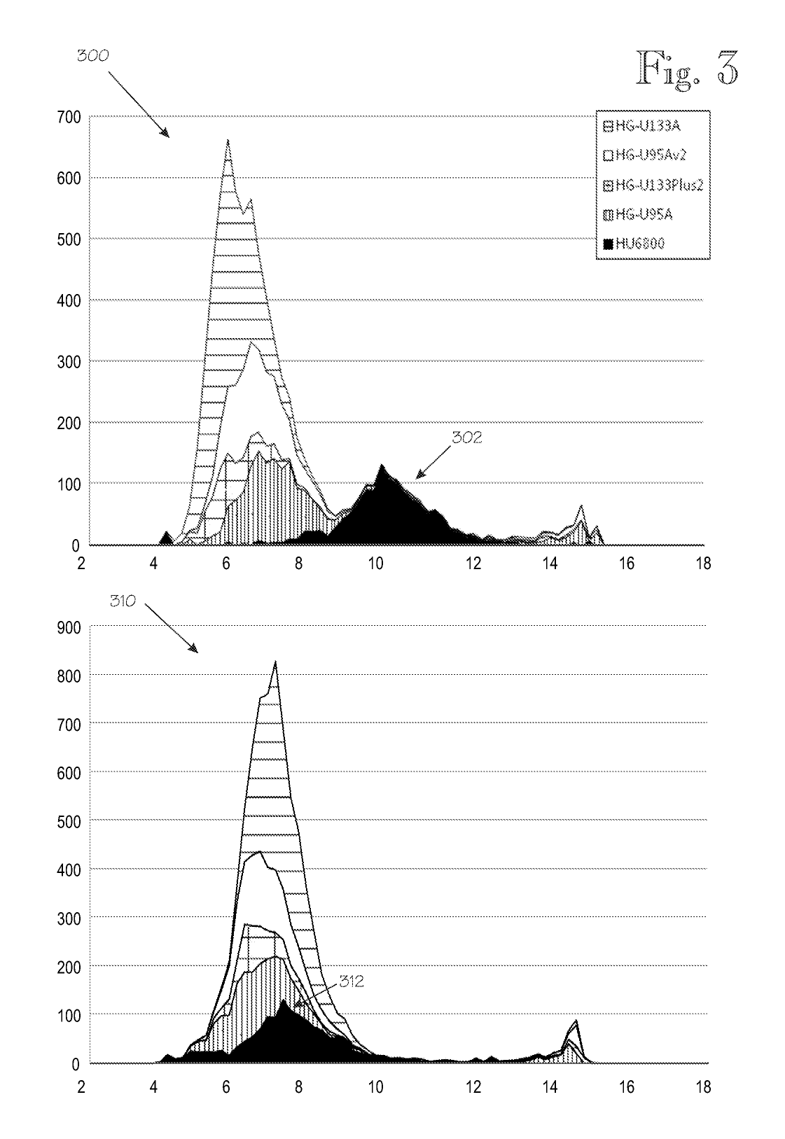

FIG. 3 illustrates the effect of the inventive correction technique on measurements of a prostate-specific gene KLK3 made with five different microarray versions. Logarithmic expression values of gene KLK3 are plotted in five distribution curves, each distribution curve corresponding to a specific microarray version and indicates the distribution of logarithmic expression values of gene KLK3. Reference numerals 300 and 310 denote two sets of five distributions as measured with five Affymetrix microarray versions HG-U133A, HG-U95Av2, HG-U133 Plus2, HG-U95 and HU6800. Distribution set 300 indicates distributions of logarithmic expression values of the five microarray versions after intra-version normalization (cf. step 106 in FIG. 1 and item 212 in FIG. 2). In other words, distribution 300 reflects results which have been normalized but not corrected with the gene- and version-specific correction element. As shown in the distribution 300, the distribution produced by microarray version HU6800, denoted by reference numeral 302, contains abnormally large values.

Distribution set 310 shows distributions of logarithmic expression values of the five microarray versions after processing by a method according to the invention, which includes correcting the gene expression values by the inventive gene- and version-specific correction element (cf. steps 108-112 in FIG. 1 and item 226 in FIG. 2). In the distribution set 310, the distribution produced by microarray version HU6800 is denoted by reference numeral 312. It can be seen that the abnormally large values produced by microarray version HU6800 have been greatly diminished without loss of dynamic range for this gene.

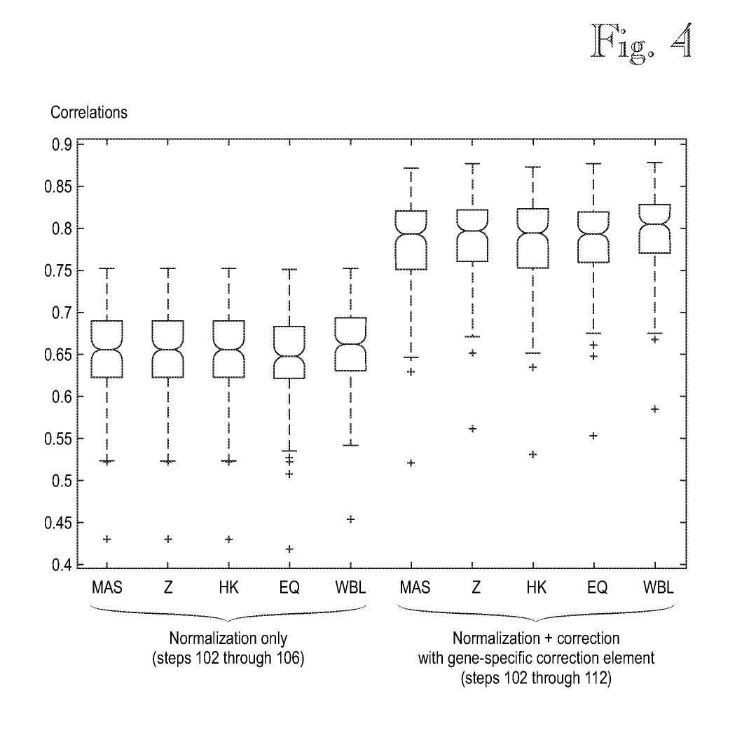

FIG. 4 shows results of another method for comparing the goodness of the normalization methods, with and without the inventive correction with the gene-specific correction element. This method involves studying the correlation between technical replicates. The inventors have utilized an experiment series from St. Jude University (Yeoh et al., 2002; Ross et al., 2003) with 132 replicated RNA samples, each made with both HG-U95Av2 and HG-U1331A. Correlations between these samples with each normalization method were calculated. This comparison method has been used in several studies. Since correlation is linearly invariant, the results are identical for MAS, Z and HK methods. Of the normalization-only methods, ie methods without the inventive correction with the gene-specific correction element, WBL normalization gave the best results. The significance of the results were calculated using one way ANOVA with Tukey's HSD. When any of the normalization methods was used in combination with the inventive correction with the gene-specific correction element, the correlations increased significantly with significance level α=0.01. In this test, best results were obtained with a combination of WBL normalization with the inventive correction with the gene-specific correction element, but the differences among the normalization methods were not significant.

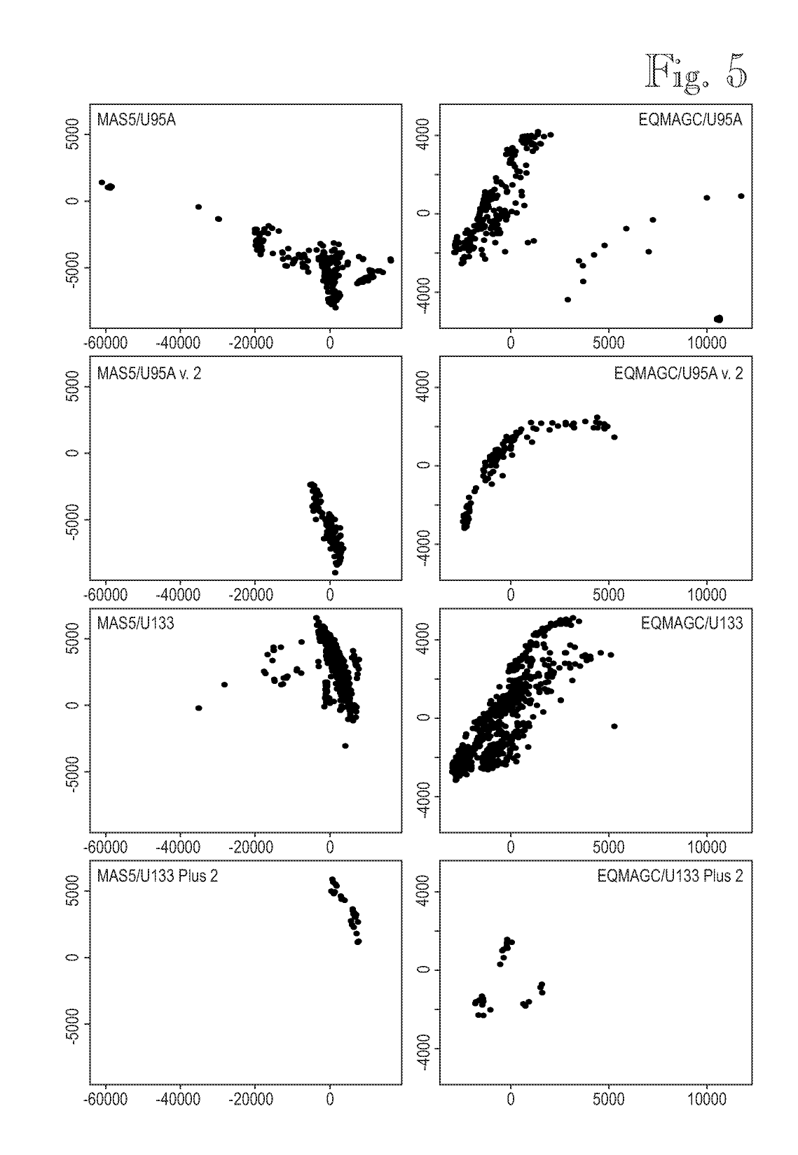

FIG. 5 also illustrates the effect of the inventive correction technique. FIG. 5 shows eight data sets organized in two columns of four rows each. The data sets were obtained from measurements with four microarray versions such that the total number of microarrays was more than one thousand. The data sets represent results of multi-dimensional scaling (“MDS”) among the more than one thousand microarrays, wherein each microarray measured an extensive collection of healthy human tissues. Next the Euclidian distances between the microarray measurements were calculated. These distances were visualized with the MDS algorithm in two dimensions. Each of the four rows corresponds to one microarray version (U95A, U95 v. 2, U133 or U133 Plus 2). The left-hand column shows results obtained from Affymetrix's MAS5 algorithm, while the right-hand hand column shows results obtained from a method according to an embodiment of the invention. It is apparent even to the naked eye that within the left-hand column, which is based on four datasets obtained from four different microarray versions, the array version itself is the biggest contributing factor to the differences among the datasets. On the other hand, within the right-hand column, which is similarly based on datasets obtained from four different microarray versions but after processing by a method according to an embodiment of the invention, the biggest contributing factor to the differences is the biological signal. In other words, data sets obtained from microarrays measuring different tissues differ from each other far more significantly than do datasets obtained from microarrays of different versions.

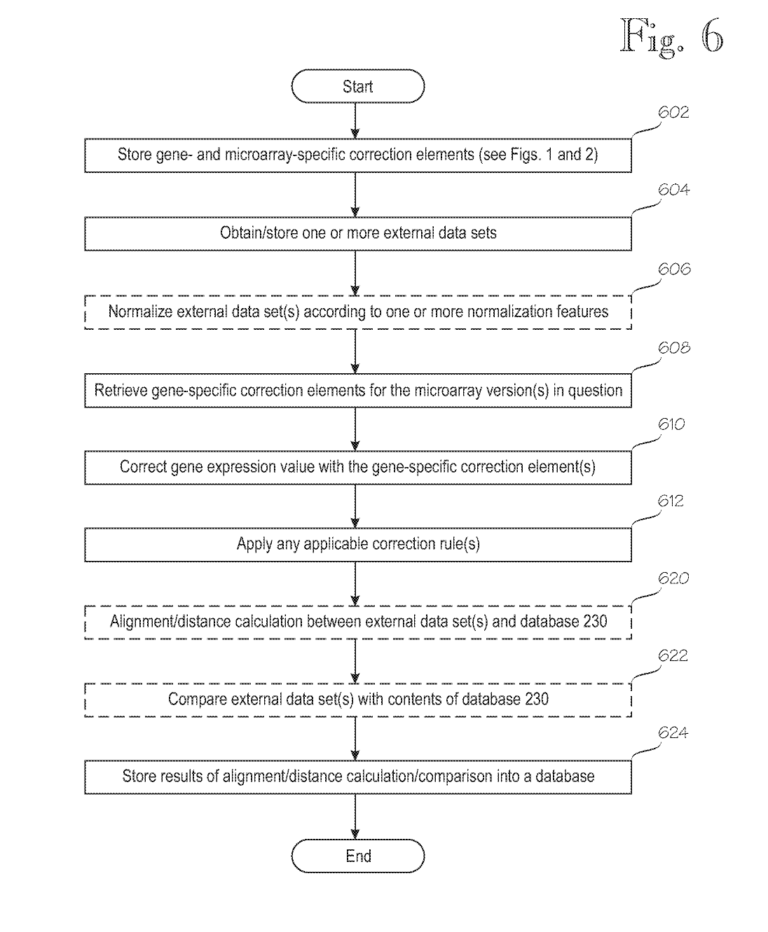

FIG. 6 illustrates an embodiment of the inventive method which is used to correct readings from an “external” microarray. As used herein, an external microarray means a microarray whose output values did not contribute to the determination of the gene- and microarray-specific correction elements. In other words, they were not used in the processes shown in FIGS. 1 and 2.

Step 602 comprises storing the gene- and microarray-specific correction elements. These correction elements can be determined by carrying out a process according to the invention, embodiments of which are described in connection with FIGS. 1 and 2. Alternatively, the correction elements may be obtained from an entity which has carried out the inventive process.

Steps 604 through 612 are analogous with those described in connection with FIG. 1, and a detailed description is omitted. The difference between the steps 102 to 116 shown in FIG. 1 and steps 604 to 612 shown in FIG. 6 is that in the process of FIG. 6 the currently-processed data set(s) do not contribute to determination of the gene- and microarray-specific correction elements.

An optional step 620 comprises alignment and distance calculation between the data set(s) obtained from the external microarray(s) and the data obtained from the processes shown in FIGS. 1 and 2. Step 620 can be considered to contain all operations wherein data set(s) from external microarray(s) are mathematically related to the content(s) of a database 230. Another optional step 622 comprises comparing the data set(s) obtained from the external microarray(s) with the contents of the database 230. Finally, step 624 comprises storing results of alignment/distance calculation/comparison 602 (and 622, if performed) into a database.

The process shown in FIG. 6 shows how the results of the inventive process, namely the gene- and microarray-specific correction elements, can be applied to data sets which were not part of the process which created the inventive correction elements.

It is readily apparent to a person skilled in the art that, as the technology advances, the inventive concept is not restricted to measuring gene expression values by microarrays. Instead the inventive concept is applicable to many other types of measurement devices wherein biological entities or samples occupy multiple measurement spots simultaneously such that the measurements spots are separated from one another.

Furthermore, the invention and its embodiments are not restricted to correction of gene expression values. Instead the properties of the biological entities or samples measured by the parallel measurement devices may include any of the following, singly or in various combinations:
Ribo- and/or deoxyribonucleic acid sequences (RNA/DNA) including but not restricted to genes (including splice variants of genes (combinations of exons), exons of genes and introns of genes); various small RNAs (including miRNA and snRNA); and genomic regulatory regions of any of the above-mentioned entities;
Amino acid sequences including but not restricted to proteins or peptides;
Various metabolites and signalling molecules/atoms including but not restricted to carbohydrates; lipids; ions and other small molecular compounds (which may be partially overlapping with sugars, lipids and ions).

An illustrative but non-exhaustive list of quantitative or semi-quantitative properties of the above mentioned entities which can be measured with parallel measurement devices includes abundance, activity, conformation, binding affinities between above mentioned elements, phosphorylation, methylation, acetylation status, etc. The list further includes properties derived through sequencing of RNA/DNA and amino acid sequences with massively parallel sequencing technology, such as Solexa sequencing technology by Illumina, inc.

Based on the above detailed description, those skilled in the art will realize that some substitutions must be made when the inventive technique is applied to correction of measurement data other than gene expression values produces by microarrays. For instance, when proteins are measured, antibodies may be substituted for probe sets. In this scenario, also the genome chart 208 is irrelevant and omitted.

Thus the invention and its embodiments are not limited to the examples described above but may vary within the scope of the claims.

### REFERENCES

Various intra-dataset normalization algorithms are disclosed in the following references, which are incorporated by reference herein:
EQ normalization is disclosed in “A Strategy for Identifying Class-Separating Genes in Drug-treatment Microarray Data” by Hautaniemi, S., Kauraniemi, P., Rämö, P., Yli-Harja, O., Astola, J., Kallioniemi, A.; Report 1. 2003. Institute of Signal Processing, Tampere University of Technology, Finland.
HK normalization is disclosed in “Normalizing DNA Microarray Data” by Bilban, M., et al., Curr. Issues Mol. Biol, 2002. 4(2): p. 57-64.
WBL normalization is disclosed in “The Weibull Distribution Based Normalization Method for Affymetrix Gene Expression Microarray Data” by Autio, R.; Kilpinen, S.; Saarela, M.; Hautaniemi, S.; Kallioniemi, O.; Astola, J.; Genomic Signal Processing and Statistics, 2006. GENSIPS apos;06. IEEE International Workshop, May 2006 Page(s): 9-10
MAS5 algorithm is available from Affymetrix and is disclosed at address http://www.Affymetrix.com/support/technical/technotes/statistical_reference_guide.pdf.

The following references disclose verification methods which were used in the creation of FIGS. 3 through 5:
Yeoh, E. J., Ross, M. E., Shurtleff, S. A., Williams, W. K., Patel, D., Mahfouz, R., Behm, F. G., Raimondi, S. C., Relling, M. V., Patel, A., Cheng, C., Campana, D., Wilkins, D., Zhou, X., Li, J., Liu, H., Pui, C. H., Evans, W. E., Naeve, C., Wong, L. and Downing, J. R. (2002): “Classification, subtype discovery, and prediction of outcome in pediatric acute lymphoblastic leukemia by gene expression profiling”, Cancer Cell. Mar; 1(2):133-43
Ross, M. E., Zhou, X., Song, G., Shurtleff, S. A., Girtman, K., Williams, W. K., Liu, H. C., Mahfouz, R., Raimondi, S. C., Lenny, N., Patel, A. and Downing, J. R. (2003) “Classification of pediatric acute lymphoblastic leukemia by gene expression profiling”, Blood. Oct 15; 102(8):2951-9.

1-15. (canceled)

16. A computer-implemented method for correcting data sets from measurements of properties of biological samples made with several different versions of a parallel measurement device, wherein the several different versions originate from one or more manufacturers and differ from one another in respect of at least one of hardware, software or measurement protocol;
the method comprising:
obtaining data sets wherein each data set contains property values of several properties of a biological sample, wherein the property values of the data set are based on measurements made with one of the several different versions of the parallel measurement device;
storing the obtained data sets, wherein the storing comprises associating each data set with an indication of the version of the parallel measurement device on which the data set is based;
determining at least one first property-specific distribution parameter and at least one second property-specific distribution parameter for each property, wherein the at least one first property-specific distribution parameter is determined for each version i of the parallel measurement device and the at least one second property-specific distribution parameter is determined for a combination of one or more of the versions of the parallel measurement device, wherein said combination of the one or more the versions comprises at least one version other than version i;
determining a property-specific correction element for each version of the parallel measurement device based on the discrepancy between the at least one first property-specific distribution parameter and the at least one second property-specific distribution parameter;
correcting a property's property value with the property-specific correction element for the version of the parallel measurement device on which the property's property value is based, thereby producing the property's corrected property value; and
outputting the property's corrected property value to a physical memory and/or display.

17. The method according to claim 16, further comprising:
maintaining a computer-readable correction rule set; and
correcting the corrected property value with the computer-readable correction rule set.

18. The method according to claim 16, wherein the correction rule set comprises the following rule:
maintaining a low-cut limit and a high-cut limit such that N1 percent of properties are below the low-cut limit and N2 percent of properties are above the high-cut limit, wherein N1 and N2 are between 0.1 and 10, preferably between 0.5 and 5 and optimally about 2; and
reducing the effect of the property-specific correction element if the property's corrected property value is below the low-cut limit or above the high-cut limit.

19. The method according to claim 16, wherein the step of storing the obtained data sets comprises checking if some of the obtained data sets are duplicates and eliminating at least some of the duplicates.

20. The method according to claim 19, wherein the step of eliminating duplicates comprises analysing the contents of the data sets.

21. The method according to claim 20, wherein the step of analysing the contents of the data sets comprises calculating and storing a hash value for each data set.

22. The method according to claim 16, wherein the distribution parameter is selected from a group which comprises average value, mean value, and n^{th} percentile value.

23. The method according to claim 16, further comprising normalizing a plurality of the stored data sets according to one or more normalization features prior to said determining at least one first property-specific distribution parameter.

24. The method according to claim 16, wherein the property includes one or more genes and the property values include expression values of the one or more genes.

25. The method according to claim 16, wherein the property includes one or more ribo- and/or deoxyribonucleic acid sequences.

26. The method according to claim 16, wherein the property includes sequencing of ribo- and deoxyribonucleic acids, proteins and/or peptides and the property values include quantitative or semi-quantitative data derived from the sequencing.

27. The method according to claim 16, wherein the property includes metabolites.

28. The method according to claim 16, wherein the property includes one or more aminoacid sequences.

29. A computer system for correcting data sets from measurements of properties of biological samples made with several different versions of a parallel measurement device, wherein the several different versions originate from one or more manufacturers and differ from one another in respect of at least one of hardware, software or measurement protocol;
the computer system comprising:
input means for obtaining data sets wherein each data set contains property values of several properties of a biological sample, wherein the property values of the data set are based on measurements made with one of the several different versions of the parallel measurement device;
a database for storing the obtained data sets and for associating each data set with an indication of the version of the parallel measurement device on which the data set is based;
first program means for determining at least one first property-specific distribution parameter and at least one second property-specific distribution parameter for each property, wherein the program means are operable to determine the at least one first property-specific distribution parameter for each version i of the parallel measurement device and the at least one second property-specific distribution parameter for a combination of one or more of the versions of the parallel measurement device, wherein said combination of the one or more the versions comprises at least one version other than version i;
second program means for determining a property-specific correction element for each version of the parallel measurement device based on the discrepancy between the at least one first property-specific distribution parameter and the at least one second property-specific distribution parameter;
third program means for correcting a property's property value with the property-specific correction element for the version of the parallel measurement device on which the property's property value is based, thereby producing the property's corrected property value; and
output means for outputting the property's corrected property value to a physical memory and/or display.

30. A computer-readable set of program media containing program code instructions for controlling operation of a computer system, wherein execution of the program code instructions in the computer system causes the computer system to carry out the steps of claim 16.
